(19) United States
(12) Patent Application Publication
(10) Pub. No.: US 2014/0025275 A1
(43) Pub. Date: Jan. 23, 2014

(54) Highway Speed Information System

(71) Applicant: Charles Kindel, Katy, TX (US)

(72) Inventor: Charles Kindel, Katy, TX (US)

(21) Appl. No.: 13/935,950

(22) Filed: Jul. 5, 2013

Related U.S. Application Data
(63) Continuation of application No. 13/873,318, filed on Apr. 30, 2013.
Application No. 13/873,318 is a continuation of application No. 13/680,681, filed on Nov. 19, 2012.
(60) Provisional application No. 61/672,410, filed on Jul. 17, 2012.

(51) Int. Cl. G08G 1/0967; B60K 31/00

(52) U.S. Cl. CPC G08G 1/096783; B60K 31/00
USPC 701/93

(57) ABSTRACT

A highway speed information system for use with a vehicle includes an in-vehicle speed information device selectively installed in a vehicle equipped with a cruise control module. The information device includes a processor, memory, and an output device. A global position system (GPS) is in data communication with the processor and configured to determine a geographic location of the vehicle. The memory is configured to store programming and a speed zone database indicative of a plurality of speed zones defined by GPS coordinates. Programming determines a current geographic location of the vehicle and associated speed limit, as well as a new current geographic location after a predetermined time—each location being associated with a speed limit. If the cruise control module is activated, it is automatically set to the speed limit associated with the current geographic location.

### CROSS REFERENCE TO RELATED APPLICATION

This application claims the benefit of non-provisional patent application Ser. No. 13/873,318, filed on Apr. 30, 2013 titled Highway Speed Information System, which claims the benefit of non-provisional patent application Ser. No. 13/680,681 filed on Nov. 19, 2012, titled Highway Speed Information System, which claims the benefit of provisional application Ser. No. 61/672,410 filed on Jul. 17, 2012, titled Highway Speed Information System.

### BACKGROUND OF THE INVENTION

This invention relates generally to information systems and, more particularly, to a highway speed information system that includes an in-vehicle display device having a database of speed zones and configured to alert a driver when a speed limit has or will soon be changing.

A familiar problem experienced by drivers on long road trips or just when driving on unfamiliar highways is not knowing the current speed limit. The lack of knowledge of a current speed limit may be due to long distances between speed limit signage, driver inattentiveness to speed signage, or a lack of memory of what was indicated on previous signage. Over the course of a long road trip, a driver may simply have an incorrect recollection of passed speed limit signs, especially if he has stopped for a restroom or food break. A related problem is determining when a speed limit has changed when driving from one geographic area (such as in a city) to another geographic area (such as a rural area).

Therefore, it would be desirable to have a highway speed information system that includes speed signage configured to transmit speed signals and in-vehicle display devices that display the speed data transmitted by the speed signage. Further, it would be desirable to have a highway speed information system configured to communicate with global position satellite systems so that highways may be displayed along with associated speed limits. In addition, it would be desirable to have a system that anticipates when a speed limit change is coming up and communicates that change before and when the speed limit changes.

### SUMMARY OF THE INVENTION

A highway speed information system for use with a vehicle includes an in-vehicle speed information device selectively installed in a vehicle. The information device includes a processor, memory, and an output device. A global position system (GPS) is in data communication with the processor and configured to determine a geographic location of the vehicle. The memory is configured to store programming and a speed zone database indicative of a plurality of speed zones defined by GPS coordinates. Programming determines a current geographic location of the vehicle and associated speed limit, a new current geographic location after a predetermined time, and a predicted future geographic location—each location being associated with a speed limit. The output device is alerted if the speed limit associated with the future location is different than the speed limit associated with the current location.

In another aspect of the invention, the processor is in data communication with the cruise control module of the vehicle. When the cruise control is switched on, the processor will set it according to the speed limit associated with the vehicle's current geographic location. Specifically, the GPS coordinates indicative of the vehicle's location are used to look up an associated speed limit from the speed zone database. Then, the processor actuates the cruise control to match that speed, such as by actuating the vehicle's accelerator or allowing the vehicle to just coast for a period of time, as the case may be. If the current speed limit changes while the cruise control module remains in use, then the processor actuates the cruise control to the new speed.

Therefore, a general object of this invention is to provide a highway speed information system that communicates a highway speed from respective signage to a passing vehicle so that the driver is made aware of an intended speed.

Another object of this invention is to provide a highway speed information system, as aforesaid, that monitors a plurality of geographic speed zones and alerts a user if the speed limit will be changing soon based on the trajectory of the moving vehicle.

Still another object of this invention is to provide a highway speed information system, as aforesaid, that actuates the vehicle's cruise control to be equal to a current speed limit of a respective speed zone in which a vehicle is located.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front perspective view of a speed sign assembly of a highway speed information system according to a preferred embodiment of the present invention;

FIG. 2 is a rear perspective view of the speed sign assembly of FIG. 1;

FIG. 3 is an isolated view on an enlarged scale taken from a lower angle of FIG. 2;

FIG. 4 is a block diagram of the highway speed information system;

FIG. 5 is a perspective view of an in-vehicle speed information device according to the present invention in use in a vehicle;

FIG. 6 is a front view on an enlarged scale of the information device as in FIG. 5;

FIG. 7 is a flowchart illustrating the logic of programming performed by a processor of the information device;

FIG. 8 is a schematic diagram illustrating a plurality of speed zones in which sets of global position system coordinates are associated with respective speed limits;

FIG. 9 is a flowchart illustrating the logic of programming performed by a processor of the information device relative to the speed zones of FIG. 8; and

FIG. 10 is a flowchart illustrating the logic of programming performed by a processor relative to automatically setting the vehicle's cruise control module according to a current speed limit.

### DESCRIPTION OF THE PREFERRED EMBODIMENT

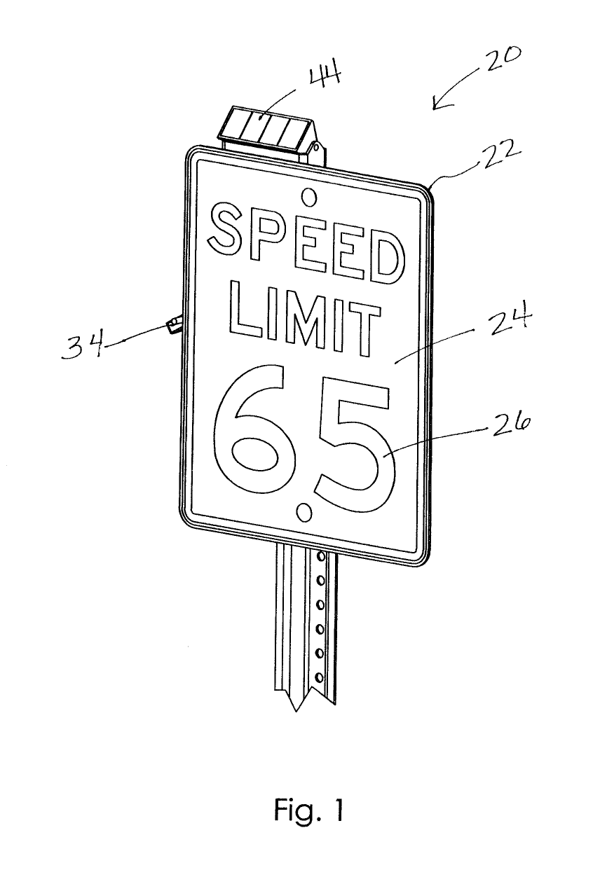

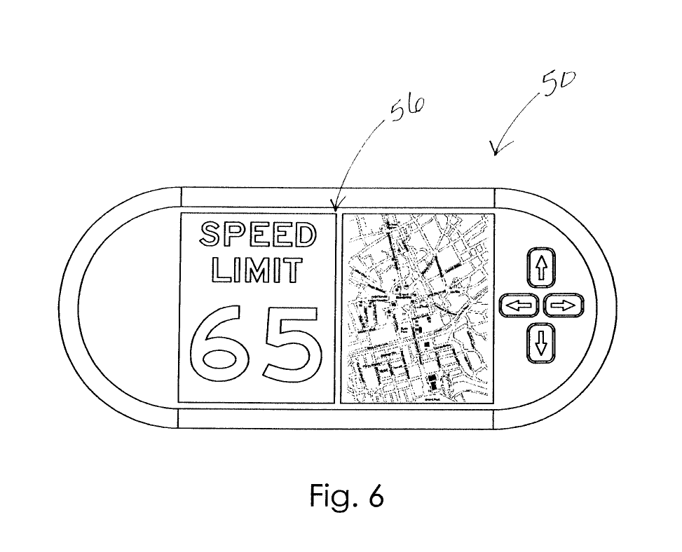

A highway speed information system according to a preferred embodiment of the present invention will now be described in detail with reference to FIGS. 1 to 10 of the accompanying drawings.

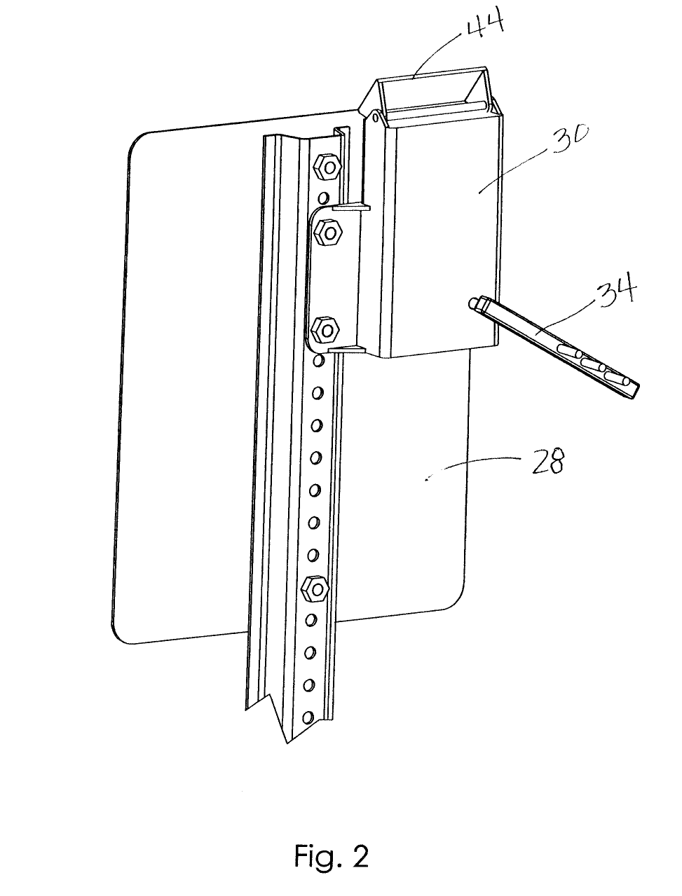

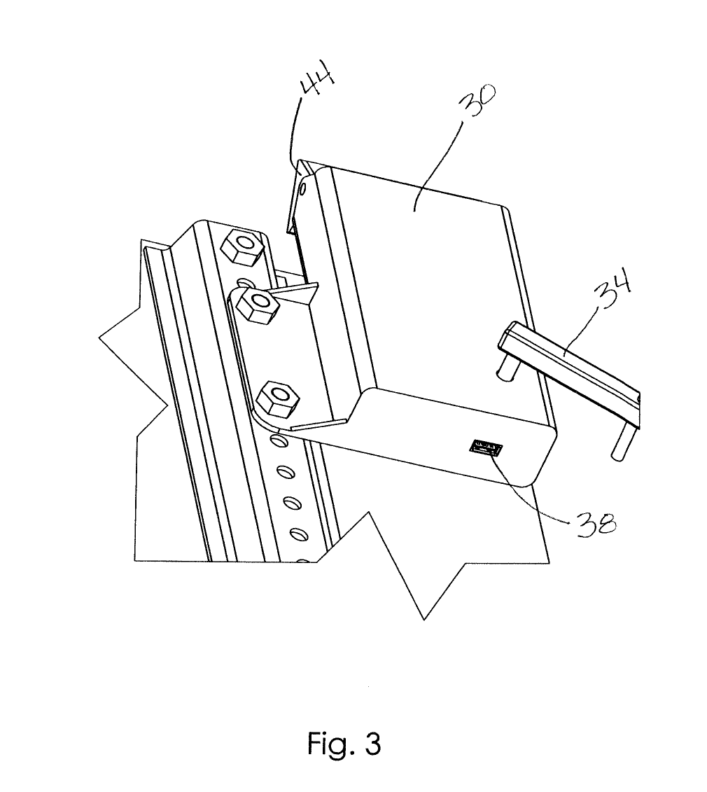

The highway speed information system 10 includes at least one but preferably a plurality of highway roadside speed sign assemblies 20. Each speed sign assembly 20 may include a speed sign 22 having a front side 24 and a back side 28. The front side 24 of the speed sign 22 may include indicia 26 indicative of a speed limit, e.g. 65 mph. A speed sign assembly 20 may include an electronics housing 30 coupled to the back side 28 of the speed sign 22 (FIGS. 2 and 3). The housing 30 may define an interior area in which electronic components may be situated.

Each speed sign assembly 20 includes a transmitter 32 that is positioned in the housing interior area and configured to transmit a signal encoded with a predetermined intended highway speed. A transmitter antenna 34 may be coupled to an outside of the housing 30 and electrically connected to the transmitter 32 inside the housing 30, the antenna 34 being configured to convert a signal associated with the predetermined speed limit to be broadcast as radio waves. Each speed sign assembly 20 may also include an input device 36 configured to set the speed to be transmitted by the transmitter 32. For instance, a highway worker may be authorized to set the speed data to be transmitted, such as upon installation of the roadway sign, at a time at which the speed limit is to be changed, or if the electronic components need to be replaced. The input device 36 may be a universal serial bus port 38 (“USB”) positioned in a housing wall (FIG. 3) to which another electronic device such as a portable memory device, e.g. a memory stick or flash drive, may be electrically connected. Alternatively, the input device 36 may include a keyboard or keypad.

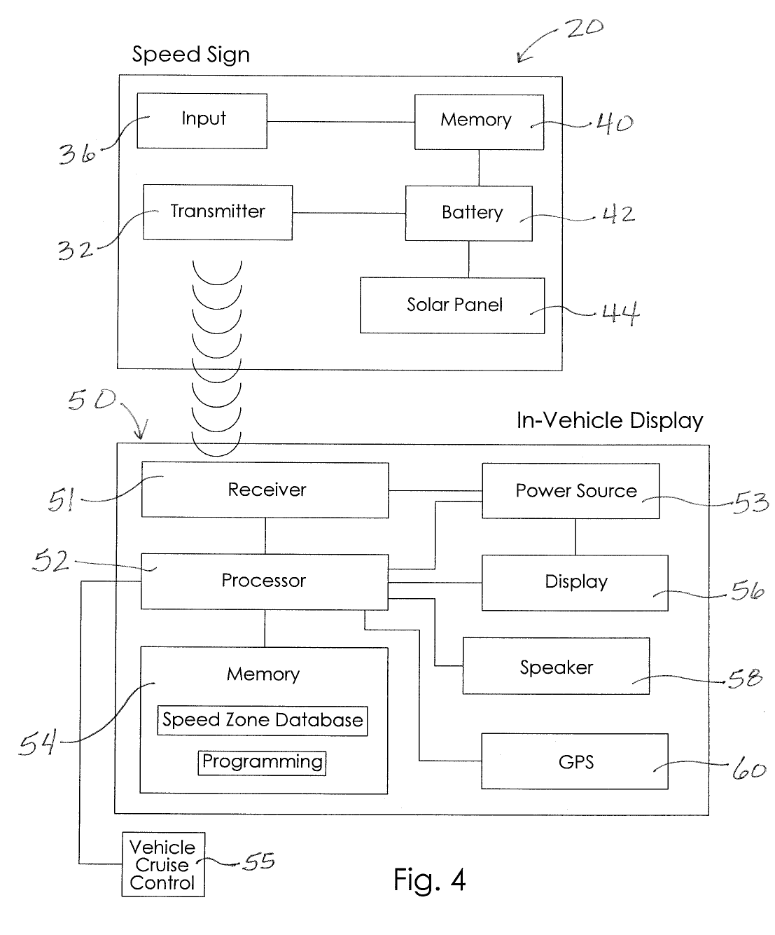

The speed sign assembly 20 may also include a speed sign memory 40 in electrical communication with the input device 36 and the transmitter 32, the speed sign memory 40 being configured to store the predetermined or user input speed value to be transmitted. The transmitter 32 may be configured to transmit the speed signal continuously or at predetermined intervals of time. The speed sign assembly 20 may also include a battery 42 connected to the other electrical components to provide electrical current thereto. The battery 42 may be rechargeable such as by an interconnected solar panel 44 (FIGS. 2 and 4).

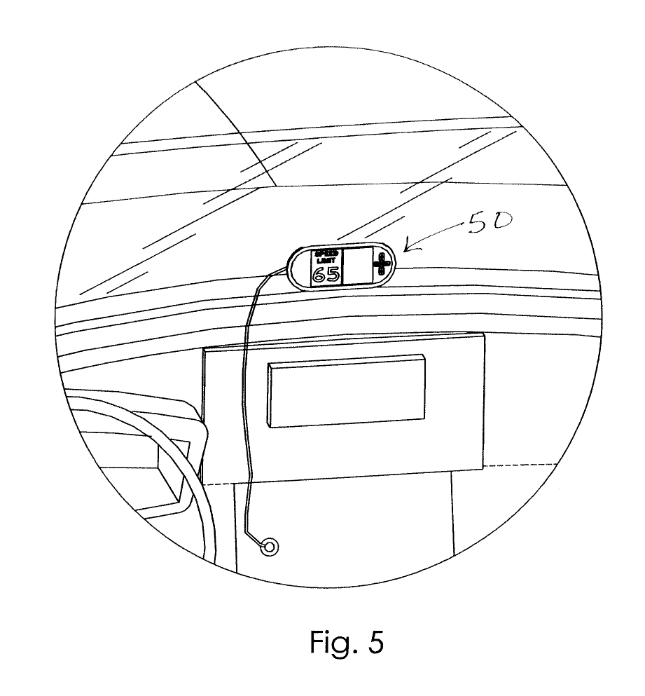

The highway speed information system 10 includes at least one but preferably a plurality of in-vehicle speed information devices 50. Each information device 50 is configured to be used with a vehicle. It is understood that an information device may be configured as a portable consumer electronic device, as in the manner of a global position system (“GPS”) device or may be installed in the vehicle at the point of manufacture. As shown in FIG. 5, the information device 50 may be mounted or positioned on the dash of an automobile and electrically connected to the automobile's battery such as via the cigarette lighter.

The in-vehicle information device 50 may include a receiver 51 configured to receive a signal transmitted by a speed sign assembly transmitter 32. The information device 50 may also include a processor 52 and an information device memory 54. The information device memory 54 includes data structures configured to store speed data indicated by the received signal and also includes programming instructions. The information device 50 may also include an output device electrically connected to the processor 52. The output device may be a display 56. The programming includes instructions that when executed by the processor 52 causes the speed data received by the receiver 51 and stored in the information device memory 54 to be published on the display 56. In practice, therefore, the receiver 51 receives a signal indicative of an intended highway speed limit when a vehicle carrying a vehicle information device passes by the speed sign assembly 20, stores it in the information device memory 54, and displays an associated speed on the information device display 56 for the driver's reference. The programming may also include instructions that when executed determines if the received speed data has changed from the previously received data and, if it has changed, updates the display 56. The information device 50 may include a power source 53 such as a battery or may be configured to plug in to the vehicle's battery power source.

Alternately, or in addition, the output device may include a speaker 58. The programming may include instructions that when executed by the processor 52 causes the speed data stored in information device memory 54 to be audibly output by the speaker 58. More particularly, the programming may cause the processor 52 to first determine if the speed associated with the received signal has changed with respect to an immediately previous received signal. If the processor 52 determines that a change has occurred, then the processor 52 causes the speed associated with the received signal to be audibly output by the speaker 58. In other words, the speaker 58 does not repeatedly announce the speed unless the speed associated with a received signal changes.

In another aspect of the invention, the in-vehicle information device 50 may coordinate with a traditional GPS device that may be in use in the vehicle or may, in fact, include its own GPS component. More particularly, a GPS 60 may be positioned in an in-vehicle information device 50. When activated, a map according to present GPS coordinates may be published on the display 56. Preferably, the vehicle information device 50 includes programming instructions that, when executed, integrate the GPS map with the intended speed limit for each roadway. The speed limit as determined from the received signal may be displayed adjacent to or superimposed on the GPS map. This may require the GPS data to be displayed on the in-vehicle information device display 56 or, alternately, include an interface with the separate GPS device and have the speed displayed there. It is contemplated that the present inventive information system may one day be incorporated into general GPS technology.

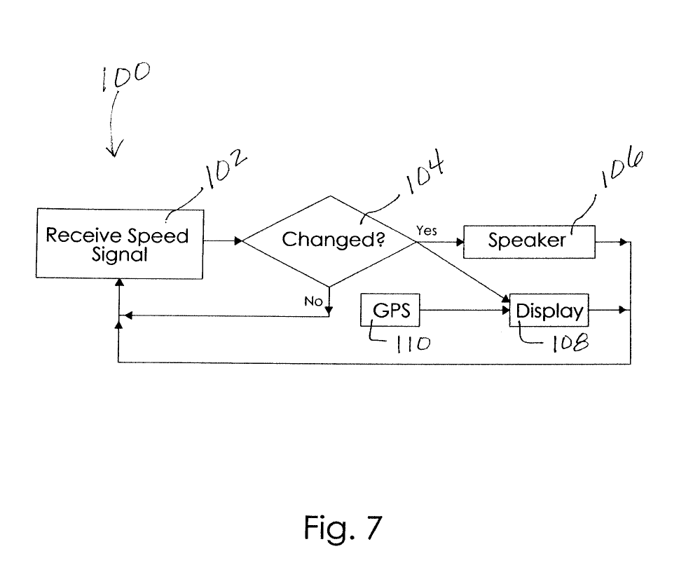

The process 100 and method of the programming executed by the processor 52 is illustrated in FIG. 7 and described below. At step 102, a signal is received by the receiver 51 of an in-vehicle information device 50 and the process 100 proceeds to step 104. At step 104, the processor 52 determines if a speed associated with the current signal has changed with respect to an immediately preceding signal and, if so, the process 100 proceeds to step 106 and 108. Otherwise, the process 100 returns to step 100 and another signal is received. At steps 106 and 108, a speed associated with a received speed signal is output to the speaker 58 and the display 56, respectively. In an embodiment that includes a GPS, step 110 causes a map corresponding to current GPS coordinates of the vehicle to be displayed by the display 56.

In one embodiment of the present invention, the process 100 may be implemented as a mobile application executed on a cellular telephone. More particularly, a properly equipped cell phone may include the hardware and software described above for the in-vehicle information device 50. For instance, the telephone may be configured to receive a signal transmitted by a roadside transmitter and then have programming configured to process the signal and make displays accordingly.

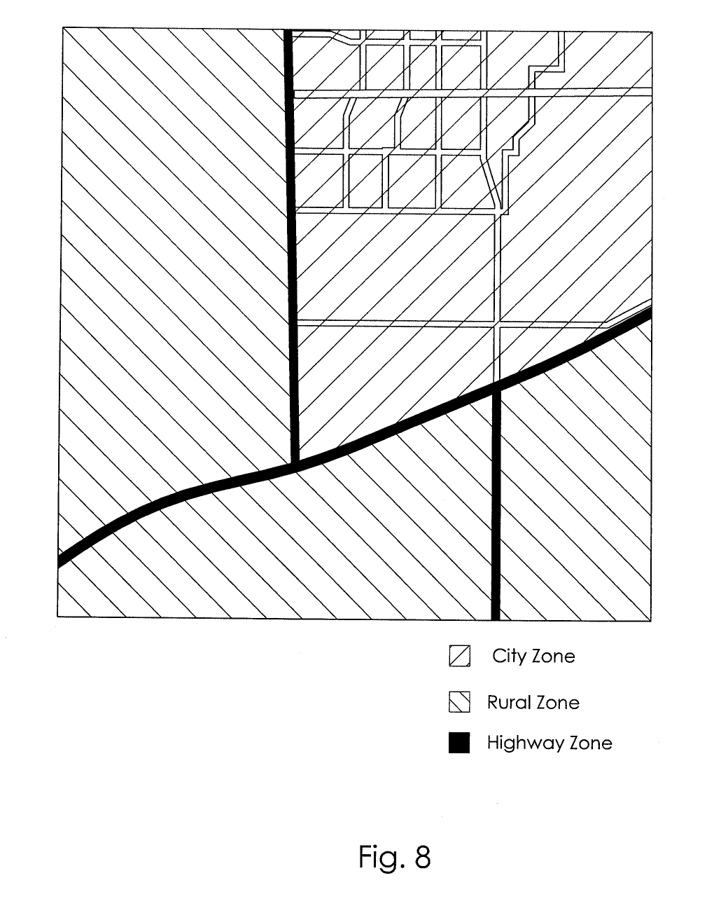

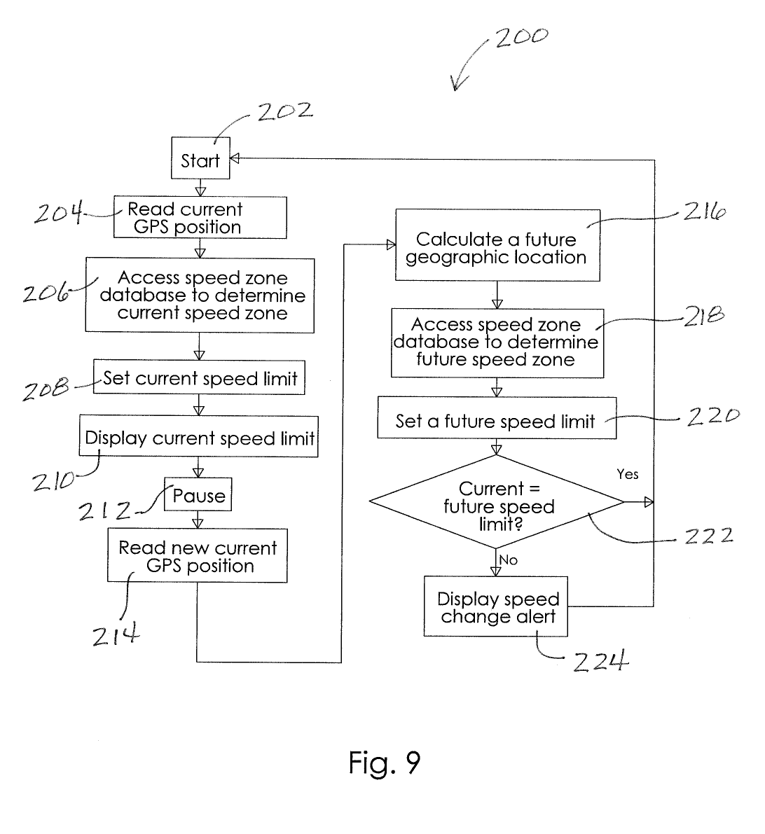

Another embodiment of the present invention is illustrated in FIGS. 8 and 9. This embodiment makes further use of the in-vehicle speed information device 50 with its processor 52, information device memory 54, and the global position system 60 (“GPS”). Specific additional programming is stored in the information device memory 54 as described below. A speed zone database is stored in appropriate data structures in the information device memory 54. The speed zone database data defines a plurality of speed zones, each speed zone being defined by a plurality of GPS coordinates and a speed limit associated with all of the geographic components located within the boundaries indicated by the GPS coordinates. Examples of a collection of speed zones are shown in FIG. 8. For instance, one speed zone may have boundaries inside of which the speed limit of all locations may be 30 mph, e.g. a “city zone.” Another speed zone may define boundaries inside which the speed limit may be 55 mph, e.g. a “rural zone.” The speed zone database may also define specific zones associated with highways. Each speed zone, therefore, is indicative of a speed limit.

Programming stored in the information device memory 54 causes the processor 52 to search the database based on current GPS data, to determine a speed zone and corresponding speed limit associated with the GPS data, to calculate a future GPS location, and, therefore, to determine if and when a changed speed limit will be encountered according to process 200 as will be described further below. As shown in FIG. 9, a process 200 is initiated at step 202. When initiated, the process 200 continues to step 204 where the processor 52 causes the GPS 60 to determine a current geographic location of the vehicle in a manner substantially similar to that described earlier. The process 200 then proceeds to step 206.

At step 206, the processor 52 accesses the speed zone database in the information device memory 54 based on the current global position data. Accordingly, the processor 52 determines from the speed zone database a respective speed zone in which the vehicle is currently located and then the process 200 proceeds to step 208. At step 208 a current speed limit data structure is set equal to a speed limit associated with the current geographic location and respective speed zone. The process 200 then proceeds to step 210.

As in the embodiment first described above, the output device may be a display 56. At step 210, the processor 52 may cause the current speed limit to be published by the display 56. The process 200 proceeds to step 212 where the processor 52 causes the process 200 to pause for a predetermined amount of time, such as a few seconds or perhaps a minute or more. As will be understood more clearly below, process 200 determines two or more locations of a traveling vehicle so as to intelligently predict a future geographic location that may be indicative of a changed speed limit. After executing the pause at step 212, the process 200 proceeds to step 214.

At step 214, the processor 52 causes the GPS 60 to determine a new current geographic location of the vehicle and then proceeds to step 216. Optionally, the processor 52 may cause the new current geographic location and its associated speed limit to be published by the display 56. At step 216, the processor 52 executes programming to calculate a “hypothetical” or “predicted” future geographic location of the vehicle if the course as indicated by the initial and new current geographic locations is continued for a predetermined amount of time. After determining a future geographic location, the process 200 continues to step 218. At step 218, the processor 52 accesses the speed zone database in the information device memory 54 based on the predicted future current global position data. An associated future speed limit is determined based on the determined future speed zone. Optionally, the processor 52 may cause the future current geographic location and its associated speed limit to be published by the display 56. Accordingly, the processor 52 determines from the speed zone database a respective speed zone in which the vehicle is predicted to be located and then the process 200 proceeds to step 220. At step 220 a future speed limit data structure is set equal to a speed limit associated with the future geographic location and corresponding speed zone. The process 200 then proceeds to step 222.

At step 222, the processor 52 determines if the current speed limit (first set at step 208) is equal to the future speed limit (set at step 220). If so, then the process 200 returns to step 202 and the process 200 begins again to calculate current and subsequent geographic locations as described above. This result is indicative that the vehicle is currently and will remain in the same speed zone and will maintain the same speed limit. The display 56 will continue to display the current speed limit. However, if the current speed limit is not equal to the future speed limit, then the process 200 proceeds to step 224 and the processor 52 causes the future speed limit to be published by the display 56 or to actuate another alert, e.g. an audible alert. Then, the process 200 proceeds to step 202 and the process 200 begins again. Preferably, the publishing of a changed future speed limit is displayed while the initial current speed limit is still being published so that they may be contrasted by a driver or so that the driver may begin to decelerate the vehicle.

Returning to step 216 at which a future geographic location of the vehicle is determined, the programming to determine a future geographic location of the vehicle includes programming to determine a direction of travel by comparing the initial current geographic location to the new current geographic location. Further, the programming to determine a future geographic location of the vehicle includes programming to determine a speed of travel by determining a distance that was travelled in an elapsed time between determining the initial current geographic location and determining the new current geographic location. Further, there is programming to determine a predicted distance of continued travel from the new current geographic location based on the determined direction and speed of travel.

In use, the aspect of the present invention illustrated in FIGS. 8 and 9 enables the processor 52 to anticipate a change in speed limit a reasonable amount of time before it is actually encountered so as to alert the driver of the vehicle of the upcoming change.

In yet another embodiment of the highway speed information system, the technologies described previously are configured to communicate and control a cruise control module 55 of a vehicle. As shown in FIG. 4, the processor 52 is in data communication with the vehicle's cruise control module 55. This communication may be with electrical wires but most likely in a wireless communication configuration. Wireless communications are preferable in that the processor 52, GPS 60, and other electronic components may be positioned inside an in-vehicle display unit 50 remote from either the vehicle's cruise control input buttons and from the operative circuitry of the cruise control module 55.

As in the embodiments described above, the information device memory 54 may include data structures and programming instructions that carry out a logical process for repeatedly setting and potentially re-setting the vehicle's cruise control module 55 while the vehicle is driven through one or more speed zones (i.e. different speed limits).

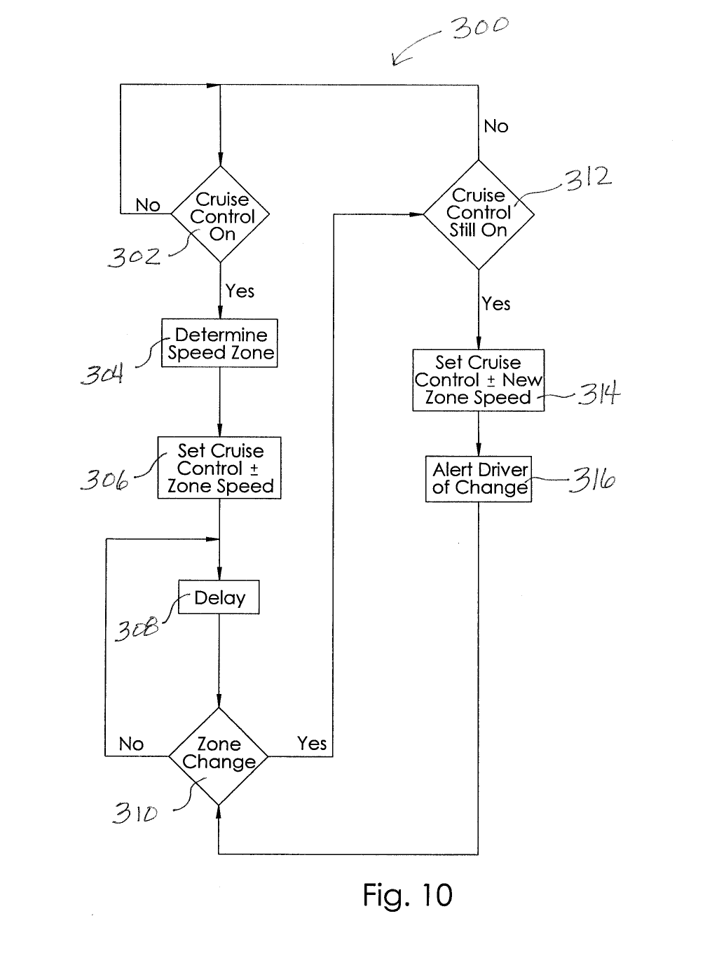

As shown in FIG. 10, a process 300 is initiated at step 302 to carry out implementation of the cruise control embodiment of the highway speed information system. At step 302, the processor 52 executes programming to determine if the vehicle's cruise control module 55 has been activated. In other words, the process 300 first determines if the driver of the vehicle has switched on the OEM cruise control switch in the vehicle as would be indicative of a desire to utilize the process 300 described below. If the cruise control module 55 is determined to be activated, then the process 300 proceeds to step 304; otherwise the process 300 just continues in a repetitive loop at step 302.

At step 304, the processor 52 determines a current speed limit associated with a current geographic location of the vehicle, in the same manner described in detail above. For instance, the GPS 60 may be accessed to determine geographic coordinates which are then matched with a respective speed limit in the speed zone database. The “current speed limit” may also be referred to as the “current zone speed.” Having determined the current speed limit, this value may be stored in memory 54 and the process 300 proceeds to step 306.

At step 306, the processor 52 sends an appropriate signal to actuate the cruise control module 55 to a speed equal to the current speed limit (also known as the “zone speed.” It is understood that the cruise control speed setting may vary slightly higher or lower than the exact speed zone determinant due to hardware qualities, signal interruptions, or if overridden by the driver. Specifically, the driver may be permitted to manually press the accelerator or brake as needed to maintain safety in heavy traffic, after which the cruise control module 55 will return to the current speed setting. The process 300 then proceeds to step 308.

At step 308, the processor 52 causes the process 300 to pause for a predetermined amount of time, such as a few seconds or perhaps a minute or more. This is to enable the vehicle to proceed a distance down the road before checking for a new speed requirement. After the delay, the process 300 proceeds to step 310. At step 310, the processor 52 determines if the vehicle has entered a different speed zone, i.e. a zone having a different speed limit. The method for determining if the vehicle has entered a new speed zone having a new speed limit has been described in detail previously with reference to process 200. If the speed zone is determined to have changed, the process 300 proceeds to step 312. Otherwise, the process 300 returns to step 308 where another delay is initiated.

At step 312, the processor 52 determines if the cruise control module 55 is still activated and, if so, the process 300 proceeds to step 314. Otherwise, the process 300 is interrupted and essentially restarts at step 302. Step 312 provides confirmation that a driver desires to continue using cruise control upon entering a new speed zone. In other words, before the processor 52 automatically adjusts the cruise control speed to a new speed limit, confirmation of the cruise control activation is made.

At step 314, the processor 52 actuates the cruise control module 55 to reach a speed that is equal to the speed limit of the zone in which the vehicle has entered. Step 314 represents the situation where a changed speed zone has already been determined (at step 310) and that cruise control is still desired (step 312). The process 300 proceeds to step 316. At step 316, the output device (display 56 or speaker 58) is actuated to alert the driver that the speed zone and speed limit have changed and that the cruise control setting is being adjusted. The step of providing an alert coincident in time with a cruise control adjustment is important to keep the driver aware of the status of his vehicle and so as not to be startled by the changes.

Accordingly, it can be seen that the highway speed information system will provide speed limit information to a driver in both real time while driving as well as proactively as part of GPS or other mapping software applications. In addition, the highway speed information system enables a driver to operate the cruise control module of his vehicle with accuracy and convenience even if not completely aware of the present speed limit of the highway.

It is understood that while certain forms of this invention have been illustrated and described, it is not limited thereto except insofar as such limitations are included in the following claims and allowable functional equivalents thereof.

1. A highway speed information system for use with a vehicle having a cruise control module, comprising:
an in-vehicle speed information device selectively installed in the vehicle;
said in-vehicle speed information device including:
a processor in data communication with the cruise control module of the vehicle;
an information device memory having data structures configured to store data and having programming instructions stored therein;
an output device electrically connected to said processor;
a global position system (“GPS”) in data communication with said processor and configured to determine a geographic location of the vehicle;
wherein said information device memory includes a speed zone database having data indicative of a plurality of speed zones, each speed zone being defined by a plurality of GPS coordinates and a speed limit associated with all geographic locations within said plurality of GPS coordinates;
programming in said information device memory that when executed by said processor causes said processor to:
determine if the cruise control module is activated;
determine from said GPS a current geographic location of the vehicle;
determine from said speed zone database a current speed limit associated with said current geographic location; and
actuate the cruise control module to a speed equal to said current speed limit.

2. The highway speed information system as in claim 1, comprising programming in said information device memory that when executed by said processor causes said processor to:
determine, after pausing for a predetermined amount of time, a new current geographic location of the vehicle;
determine from said speed zone database a new current speed limit associated with said new current geographic location; and
actuate the cruise control module to a speed equal to said new current speed limit if said new current speed limit is different from said current speed limit.

3. The highway speed information system as in claim 2, comprising programming in said information device memory that when executed by said processor causes said processor to determine that the cruise control module is activated before actuating the cruise control module to equal said new current speed limit.

4. The highway speed information system as in claim 2, comprising programming in said information device memory that when executed by said processor causes said processor to actuate said output device if said new current speed limit is different from said current speed limit

5. The highway speed information system as in claim 1, wherein:
said output device includes a display;
said information device memory includes programming that when executed by said processor causes said current speed limit associated with said current geographic location to be published by said display.

6. The highway speed information system as in claim 5, further comprising programming in said information device memory that when executed by said processor causes said new current speed limit associated with said new geographic position to be published by said display.

7. The highway speed information system as in claim 5 comprising programming in said information device memory that when executed by said processor to:
determine from said GPS current geographic location of the vehicle and said new geographic location of the vehicle a future geographic location of the vehicle;
determine from said speed zone database a future speed limit associated with said future geographic location; and
actuate said output device if said future speed limit is different from said current speed limit.

8. The highway speed information system as in claim 7, comprising programming in said information device memory that when executed by said processor causes said future current speed limit associated with said future geographic position to be published by said display.

9. The highway speed information system as in claim 7, wherein said programming to determine said future geographic location of the vehicle includes:
programming to determine a direction of travel by comparing said current geographic position to said new current geographic position;
programming to determine a current speed of travel by determining a distance that was traveled in a time between determining said current geographic location and determining said new current geographic location; and
programming to determine a predicted distance of travel over a predetermined period of time based on said current speed of travel.

10. The highway speed information system as in claim 7, wherein said programming to actuate said output device if said future speed limit is different from said current speed limit includes programming to publish said future speed limit while said current speed limit is being published by said display.

11. The information system as in claim 1, wherein:
said output device includes a speaker; and
said information device memory includes programming that when executed by said processor causes said current speed limit to be audibly output by said speaker.

12. The information system as in claim 1, further comprising:
a speed sign assembly having a transmitter configured to transmit a signal indicative of a predetermined intended highway speed;
wherein said in-vehicle speed information device includes a receiver configured to receive said signal transmitted by said speed sign transmitter; and
programming in said information device memory that when executed by said processor causes a speed associated with said received signal to be output by said output device.

13. The information system as in claim 12, further comprising:
programming in said information device memory that when executed by said processor causes said processor to determine when said speed associated with said received signal has changed with respect to an immediately previous received signal; and
programming in said information device memory that when executed by said processor causes said speed associated with said received signal to be output by said output device only when said speed has changed with respect to said immediately previous received signal.

14. The information system as in claim 13, wherein:
said output device includes a display; and
said information device memory includes programming that when executed by said processor causes said speed associated with said received signal to be published by said display.

15. The information system as in claim 12, wherein:
said speed sign assembly includes an input device electrically connected to a speed sign memory, said input device being configured to selectively enable a user to store a selected speed in said speed sign memory; and
said transmitter is configured to transmit said selected speed stored in said speed sign memory.

16. The information system as in claim 15, wherein said speed sign assembly includes a power source electrically connected to said speed sign memory and to said transmitter.

17. The information system as in claim 15, wherein said speed sign assembly includes:
a sign having a front side and a back side, said front side including indicia indicative of a speed limit;
a housing coupled to said sign back side, said housing defining an interior area;
a battery; and
wherein said speed sign memory and said battery are positioned in said housing interior area.

18. The information system as in claim 15, wherein said transmitter is configured to transmit said selected speed stored in said speed sign memory at predetermined intervals of time.

19. The information system as in claim 14, wherein said information device memory includes programming that when executed by said processor causes a map associated with said current geographic position as indicated by the GPS to be published on said display.

20. The information system as in claim 15, further comprising:
programming in said information device memory that when executed by said processor determines when said speed associated with said received signal has changed with respect to an immediately previous received signal; and
programming in said information device memory that when executed by said processor causes said speed associated with said received signal to be output by said output device only when said speed has changed with respect to said immediately previous received signal.
